(19) United States
(12) Patent Application Publication
(10) Pub. No.: US 2025/0143325 A1
(43) Pub. Date: May 8, 2025

(54) PLANT-BASED INSECT REPELLENT AND USES THEREOF

(71) Applicant: PIC Corporation, Linden, NJ (US)

(72) Inventors: Eric Rubel, Westfield, NJ (US); David L. Lowe, Port Monmouth, NJ (US); Lawrence E. Bradford, Scotch Plains, NJ (US)

(21) Appl. No.: 18/924,486

(22) Filed: Oct. 23, 2024

Related U.S. Application Data
(60) Provisional application No. 63/547,048, filed on Nov. 2, 2023.

(51) Int. Cl. A01N 65/44; A01N 25/04; A01N 31/02; A01N 65/08; A01N 65/12; A01N 65/22; A01N 65/24; A01N 65/28; A01N 65/36; A01N 65/48; A01P 17/00

(52) U.S. Cl. CPC A01N 65/44; A01N 25/04; A01N 31/02; A01N 65/08; A01N 65/12; A01N 65/22; A01N 65/24; A01N 65/28; A01N 65/36; A01N 65/48; A01P 17/00

(57) ABSTRACT

The present invention provides a composition including a mixture of essential oils and terpene alcohol. The present invention also provides an article containing a composition comprising a mixture of essential oils and terpene alcohol. The present invention further provides a method of preparing a composition comprising a mixture of essential oils and terpene alcohol.

### CROSS-REFERENCE TO RELATED APPLICATIONS

The present application claims benefit of and priority to U.S. Provisional Patent Application Ser. No. 63/547,048 filed Nov. 2, 2023 entitled PLANT-BASED INSECT REPELLENT AND USES THEREOF, the entire content of which is hereby incorporated by reference herein.

### BACKGROUND OF THE INVENTION

Throughout this application, various publications are referenced, including referenced in parenthesis. The disclosures of all publications mentioned in this application in their entireties are hereby incorporated by reference into this application in order to provide additional description of the art to which this invention pertains and of the features in the art which can be employed with this invention.

Mosquitoes are one of the most important pests that affect public health. Multiple viral diseases are spread by mosquitoes (dengue fever, chikungunya, Zika, yellow fever, etc.), affecting millions of people around the world. For years, multiple strategies have been developed to kill mosquitoes including chemical, mechanical, physical, and natural control options. Recently, multiple studies concluded that mosquitoes develop resistance to active ingredients in multiple pesticides. Because of the inefficiency of traditional pesticides, it is important to develop non-chemical mosquito control options that include lures, ecological pesticides, biological controls, traps, and repellent strategies to reduce mosquito populations with low environmental impact. The present invention focuses on an environmentally friendly option to control mosquitoes.

Increased public demand for safe, effective, and cost-efficient biting insect repellent has led to the mass marketing of natural “area repellents” such as citronella candles, which are reputed to repel biting insects within a certain distance of the source of the compound. However, quantitative studies on their effect are lacking and the results of the studies that have been done are contradictory. Additional plant-based repellents, specifically geraniol and linalool, are now available in candle form.

Area repellents create a chemical barrier that insects will not cross. The number-one-selling type of area repellent in the United States is the mosquito coil, followed by the citronella candle (Moore and Debboun 2007).

Repellent agents are generally defined as material that prevent arthropods from landing or biting on human skin. One synthetic repellent is DEET (N, N-diethyl-3methylbenzamide). The mechanism of the repent effect of DEET is based on blocking the olfactory receptors, which are mostly on antenna and maxillary palps of the insects and exposed to external environment. However, DEET is not able to block the carbon dioxide detection ability of insects found in human breath.

DEET has been associated with environmental risks and side effects such as neurotoxicity, irritation, and allergic reactions in humans, especially in children as well as in lactating and pregnant women. Accordingly, exploration of eco-friendly, biodegradable, and safe alternative repellents has accelerated. The use of plant materials (extracts or essential oils) as repellent has been known for thousands of years. Herbal materials may be applied to the skin, cloths or as fumigants to protect humans from mosquitoes. Furthermore, plant extracts are safer and easier to stock in in comparison with other synthetic chemical based repellents. Therefore, various plant materials which display repellent properties have been considered as alternatives to synthetic repellents.

### BRIEF SUMMARY OF THE INVENTION

The present invention provides a composition including a mixture of essential oils and terpene alcohol.

The present invention provides an article containing a composition comprising a mixture of essential oils and terpene alcohol.

The present invention provides a method of preparing a composition comprising a mixture of essential oils and terpene alcohol.

### DETAILED DESCRIPTION

Essential oils and their major components are emerging as potential pest control agents due to their insecticidal, repellent and/or antifeedant properties (Barnard and Xue, 2004; Papachristos et al., 2004). Their low mammalian toxicity and biodegradability favor their use. Using an impregnated fabric disc bioassay, Jeon et al. (2009) studied the acaricidal properties of geraniol from the oil of Pelargonium graveolens against the storage food mite, Tyrophagus putrescentiae, and compared the effectiveness to a commercial acaricide, benzyl benzoate. The results revealed that geraniol was more effective than benzyl benzoate with the 50% lethal dose value being 1.95·g/cm³ and 1.27· g/cm³, respectively.

Essential oils (EOs) have various chemical components, which possess insecticidal, repellent and deterrent properties (Tawatsin et al, 2006). Various chemical compositions present in EOs contribute to the efficacy of topical mosquito repellent formulations. Studies suggest that EOs might be almost as effective as DEET (Barnard 2004). The U.S. Center for Disease Control and Prevention recommends oil of lemon and eucalyptus as an alternative to DEET due to its efficacy against insects (Fradin et al, 2002). International organizations like the U.S. Environmental Protection Agency (EPA) and the World Health Organization (WHO), as well as other countries and organizations have approved several EOs for use in view of their accessibility, availability, reliability, low cost and low risk and the fact that they are not subject to federal registration requirements (Chellappandian et al. 2018). Numerous natural EO-based products are in use as insect repellents. However, plant products registered as safe and effective topical insect repellents may still have concerns related to allergenicity, mutagenicity, genotoxicity and complete protection time (Pohlit, 2011).

The present invention relates to an EO-based mosquito repellent which is effective, safe and environmentally friendly for both indoor and outdoor protection with extended protection time. It includes a blend of citronella oil, clove oil and lemongrass oil with added geraniol.

The mechanism of the insecticidal property ascribed to geraniol was investigated by testing its neurophysiological effect in Periplaneta americana (the American Cockroach) and Blaberus discoidalis (discoids). Geraniol suppressed spontaneous and stimulus-evoked impulses recorded extracellularly in the abdominal nerve cord but increased spontaneous firing at lower doses (threshold 2.5×10⁻⁴M), reversibly increased the frequency of spontaneous foregut contractions and abolished these at 2×10⁻³M (together with response to electrical stimulation).

The present invention provides a composition including a mixture of essential oils and terpene alcohol.

In some embodiments, the mixture of essential oils includes clove oil, citronella oil, lemongrass oil, peppermint oil, lavender oil, sandalwood oil, basil oil, bergamot oil, camphor oil, cinnamon oil, clove oil, eucalyptus oil, jasmine oil, lemon oil, patchouli oil, rosemary oil, wild turmeric oil, rose oil, and chamomile oil.

In some embodiments, the mixture of essential oils includes clove oil, citronella oil, lemongrass oil, peppermint oil, lavender oil, sandalwood oil, basil oil, bergamot oil, camphor oil, cinnamon oil, clove oil, eucalyptus oil, jasmine oil, lemon oil, patchouli oil, rosemary oil, and wild turmeric oil.

In some embodiments, the mixture of essential oils includes clove oil, citronella oil, lemongrass oil, peppermint oil, lavender oil, sandalwood oil, basil oil, bergamot oil, camphor oil, cinnamon oil, clove oil, eucalyptus oil, jasmine oil, lemon oil, and patchouli oil.

In some embodiments, the mixture of essential oils includes clove oil, citronella oil, lemongrass oil, peppermint oil, lavender oil, sandalwood oil, basil oil, bergamot oil, camphor oil, cinnamon oil, clove oil and eucalyptus oil, and jasmine oil.

In some embodiments, the mixture of essential oils includes clove oil, citronella oil, lemongrass oil, peppermint oil, lavender oil, sandalwood oil, basil oil, bergamot oil, and camphor oil.

In some embodiments, the mixture of essential oils includes clove oil, citronella oil, lemongrass oil, peppermint oil, and lavender oil.

In some embodiments, the mixture of essential oils includes clove oil, citronella oil, and lemongrass oil.

In some embodiments, the weight percentage of clove oil is about 1% to 20%.

In some embodiments, the weight percentage of clove oil is about 5% to 15%.

In some embodiments, the weight percentage of clove oil is about 6% to 14%.

In some embodiments, the weight percentage of clove oil is about 7% to 13%.

In some embodiments, the weight percentage of clove oil is about 8% to 12%.

In some embodiments, the weight percentage of clove oil is about 9% to 11%.

In some embodiments, the weight percentage of clove oil is 10%.

In some embodiments, the weight percentage of lemongrass oil is about 20%-40%.

In some embodiments, the weight percentage of lemongrass oil is about 21%-39%.

In some embodiments, the weight percentage of lemongrass oil is about 22%-38%.

In some embodiments, the weight percentage of lemongrass oil is about 23%-37%.

In some embodiments, the weight percentage of lemongrass oil is about 24%-36%.

In some embodiments, the weight percentage of lemongrass oil is about 25%-35%.

In some embodiments, the weight percentage of lemongrass oil is about 26%-34%.

In some embodiments, the weight percentage of lemongrass oil is about 27%-33%.

In some embodiments, the weight percentage of lemongrass oil is about 28%-32%.

In some embodiments, the weight percentage of lemongrass oil is about 29%-31%.

In some embodiments, the weight percentage of lemongrass oil is 30%.

In some embodiments, the weight percentage of citronella oil is about 20%-40%.

In some embodiments, the weight percentage of citronella oil is about 21%-39%.

In some embodiments, the weight percentage of citronella oil is about 22%-38%.

In some embodiments, the weight percentage of citronella oil is about 23%-37%.

In some embodiments, the weight percentage of citronella oil is about 24%-36%.

In some embodiments, the weight percentage of citronella oil is about 25%-35%.

In some embodiments, the weight percentage of citronella oil is about 26%-34%.

In some embodiments, the weight percentage of citronella oil is about 27%-33%.

In some embodiments, the weight percentage of citronella oil is about 28%-32%.

In some embodiments, the weight percentage of citronella oil is about 29%-31%.

In some embodiments, the weight percentage of citronella oil is 30%.

In some embodiments, the weight percentage of terpene alcohol is about 10%-50%.

In some embodiments, the weight percentage of terpene alcohol is about 15%-45%.

In some embodiments, the weight percentage of terpene alcohol is about 18%-42%.

In some embodiments, the weight percentage of terpene alcohol is about 20%-40%.

In some embodiments, the weight percentage of terpene alcohol is about 21%-39%.

In some embodiments, the weight percentage of terpene alcohol is about 22%-38%.

In some embodiments, the weight percentage of terpene alcohol is about 23%-37%.

In some embodiments, the weight percentage of terpene alcohol is about 24%-36%.

In some embodiments, the weight percentage of terpene alcohol is about 25%-35%.

In some embodiments, the weight percentage of terpene alcohol is about 26%-34%.

In some embodiments, the weight percentage of terpene alcohol is about 27%-33%.

In some embodiments, the weight percentage of terpene alcohol is about 28%-32%.

In some embodiments, the weight percentage of terpene alcohol is about 29%-31%.

In some embodiments, the weight percentage of terpene alcohol is 30%.

In some embodiments, the terpene alcohol includes cinnamyl alcohol, citronellol, geraniol, nerol, farnesol, linalool, perillyl alcohol, menthol, borneol, and carveol.

In some embodiments, the terpene alcohol includes citronellol, geraniol, nerol, farnesol, linalool, perillyl alcohol, menthol, borneol, and carveol.

In some embodiments, the terpene alcohol includes citronellol, geraniol, nerol, farnesol, linalool, perillyl alcohol, menthol, and borneol.

In some embodiments, the terpene alcohol includes citronellol, geraniol, nerol, farnesol, linalool, perillyl alcohol, and menthol.

In some embodiments, the terpene alcohol includes citronellol, geraniol, nerol, farnesol, linalool, and perillyl.

In some embodiments, the terpene alcohol includes citronellol, geraniol, nerol, farnesol, and linalool.

In some embodiments, the terpene alcohol includes citronellol, geraniol, nerol, and farnesol.

In some embodiments, the terpene alcohol includes citronellol and geraniol.

In some embodiments, the terpene alcohol is geraniol.

In some embodiments, the composition contains 30% citronella oil, 30% lemongrass oil, 10% clove oil and 30% geraniol.

In some embodiments, the composition further includes solubilizer, emulsifier, adjuvant and distilled water.

In some embodiments, the composition further includes distilled water.

In some embodiments, the weight percentage of distilled water in the composition is about 30-70%

In some embodiments, the weight percentage of distilled water in the composition is about 40-60%

In some embodiments, the weight percentage of distilled water in the composition is about 45-55%

In some embodiments, the distilled water in the composition is about 50%

In some embodiments, the composition is an oil-in-water emulsion.

In some embodiments, the composition is a topical formulation.

In some embodiments, the topical formulation is in the form of vapor, liquid, gel, cream, or ointment.

In some embodiments, the topical formulation is in the form of vapor.

In some embodiments, the topical formulation is in the form of liquid.

In some embodiments, the topical formulation is in the form of gel.

In some embodiments, the topical formulation is in the form of cream.

The present invention provides an article containing a composition including a mixture of essential oils and terpene alcohol.

The present invention provides a method of preparing a composition including a mixture of essential oils and terpene alcohol.

In some embodiments, the present invention provides a composition for use to repel insects.

In some embodiments, the present invention provides a use of a composition for repelling insects.

In some embodiments, the insect includes mosquito, crane fly, fly, winter crane fly, owl midge, wood gnat, midge, fungus gnat, gnat, dixidae, pyschodidae, and anisopodidae.

In some embodiments, the insect includes mosquito, crane fly, fly, winter crane fly, owl midge, wood gnat, midge, fungus gnat, and gnat.

In some embodiments, the insect includes mosquito, crane fly, fly, winter crane fly, owl midge, wood gnat, midge, and fungus gnat.

In some embodiments, the insect includes mosquito, crane fly, fly, winter crane fly, owl midge, and midge.

In some embodiments, the insect includes mosquito, crane fly, fly, and winter crane fly.

In some embodiments, the insect is a mosquito.

### Definitions

Unless defined otherwise, all technical and scientific terms used herein have the meaning commonly understood by persons of ordinary skill in the art to which this subject matter pertains.

As used herein, the term “a” or “an” includes the singular and the plural, unless specifically stated otherwise. Therefore, the terms “a,” “an” or “at least one” can be used interchangeably in this application.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “10-40%” includes 10.1%, 10.2%, 10.3%, etc. up to 40%.

As used herein, the term “and/or” includes any and all combinations of one or more of the associated listed items. Expressions such as “at least one of,” when preceding a list of elements, modify the entire list of elements and do not modify the individual elements of the list.

As used herein, an “essential oil” is a concentrated plant extract and includes, but is not limited to Agar oil or oodh, distilled from agarwood (Aquilaria malaccensis), Ajwain oil, distilled from the leaves of (Carum copticum). Angelica root oil, distilled from the Angelica archangelica, Anise oil, from the Pimpinella anisum, Asafoetida oil, used to flavor food, Balsam of Peru, from the Myroxylon, Basil oil, Bergamot oil, Birch oil, Black pepper oil distilled from the berries of Piper nigrum, Blue tansy (Tanacetum annuum), Buchu oil, made from the buchu shrub. Calamodin oil or calamansi essential oil, Calamus oil, Camphor oil, Cannabis flower essential oil, Caraway seed oil, Cardamom seed oil, Carrot seed oil, Cedar oil (or cedarwood oil), Chamomile oil, Cinnamon oil, Cistus ladanifer leaves and flowers oil, Citron oil, Citronella oil, Clary Sage oil, Clove oil, Coconut oil, Coffee oil, Coriander oil, Costmary oil (bible leaf oil), Costus root oil, Cranberry seed oil, Cubeb oil, Cumin seed oil/black seed oil, Curry leaf oil, Cypress oil, Cypriol oil, from Cyperus scariosus, Davana oil, from the Artemisia pallens, Dill oil, Elecampane oil, Elemi oil, Eucalyptus oil, Fennel seed oil, Fenugreek oil, Fir oil, Frankincense oil, Galangal oil, Galbanum oil, Garlic oil, Geranium oil, Ginger oil, Goldenrod oil, Grapefruit oil, Henna oil, Helichrysum oil, Hickory nut oil, Horseradish oil, Hyssop, Jasmine oil, Juniper berry oil, Lavender oil, Ledum oil, Lemon oil, Lemongrass oil, Lime oil, Litsea cubeba oil, Linalool oil, Mandarin oil, Marjoram oil, Manuka oil, Melissa oil (Lemon balm), Mentha arvensis oil, Mint oil, Moringa oil, Mountain Savory oil, Mugwort oil, Mustard oil, Myrrh oil, Myrtle oil, Neem oil or neem tree oil, Neroli oil, Nutmeg oil, Orange oil, Oregano oil, Orris oil, Palo Santo oil, Parsley oil, Patchouli oil, Perilla essential oil, Pennyroyal oil, Peppermint oil, Petitgrain oil, Pine oil, Ravensara oil, Red Cedar oil, Roman Chamomile oil, Rose oil, Rosehip oil, Rosemary oil, Rosewood oil, Sage oil, Sandalwood oil, Sassafras oil, Sassafras oil, Savory oil, Schisandra oil, Spearmint oil, Spikenard, Spruce oil, Star anise oil, Tangerine oil, Tarragon oil, Tea tree oil, Thyme oil, Turmeric oil, Valerian oil, Warionia oil, Vetiver oil (khus oil), Western red cedar oil, Wintergreen oil, Yarrow oil, and Ylang-ylang oil.

As used herein, “terpene” is any of a class of hydrocarbons occurring widely in plants and animals and empirically regarded as built up from isoprene, a hydrocarbon that includes five carbon atoms attached to eight hydrogen atoms (C₅H₈)ₙ for n·2. The term is often extended to the terpenoids, which are oxygenated derivatives of these hydrocarbons.

As used herein, “solubilizer” helps to make otherwise insoluble liquids soluble in water. It includes, but is not limited to, short-chain alcohols, alkane diols and triols, polyethylene glycols, and glycol ethers.

As used herein, “emulsifier” is used to emulsify oils in water to create O/W emulsions. Emulsifiers are used for oils and lipophilic ingredients with bigger/heavier molecules than essential oils. These oils, for example, include plant oils, fatty esters and waxes.

As used herein, the term “emulsifier” includes, but is not limited to, Acacia (gum Arabic), Acetic acid esters (ACETEM), Ammonium phosphatide, Baker's yeast glycan, Brominated vegetable oil (BVO), Carboxymethylcellulose, AKA cellulose, Carrageenan, DATEM (Diacetyl tartaric acid esters), Dextrin, Guar Gum, Lactic acid esters (LACTEM), Lecithin (soy and egg), Magnesium stearate, Mono and diglycerides, Phosphates, Polyglycerol esters (PGE), Polysorbate 60, 65, 80 (P80), Propylene glycol esters of fatty acids (PGMS), Sodium stearolyllactylate (SSL), Sorbitan monostearate, Sucrose Acetate Isobutyrate, Sucrose fatty acid ester, and Xanthum Gum.

As used herein, “adjuvant” is a drug or other substance, or a combination of substances, that is used to increase the efficacy or potency of certain drugs. It includes, but is not limited to, aluminum salts, such as aluminum hydroxide, aluminum phosphate, and aluminum potassium sulfate.

As used herein, a “CDC trap” may use several attractants to lure mosquitoes into the collection chamber. Light is the primary source, but bottled CO₂ gas or dry ice may be used.

All combinations of the various elements disclosed herein are within the scope of the invention.

As used herein, all headings are simply for organization and are not intended to limit the disclosure in any manner. The content of any individual section may be equally applicable to all sections. All combinations of the various elements disclosed herein are within the scope of the invention.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

This invention will be better understood by reference to the Examples which follow, but those skilled in the art will readily appreciate that the specific experiments detailed are only illustrative of the invention as described more fully in the claims which follow thereafter.

### Examples

An outdoor laboratory bioassay is used to assess the efficacy of the Bite Barrier Mosquito Repellent Vaporizer at repelling Mosquitoes. This is not a GLP (Good Laboratory Practices) study or protocol as defined by 40 CFR Part 160.

For the experiment, a Bite Barrier Mosquito Repellent Vaporizer containing 30% citronella oil, 30% lemongrass oil, 10% clove oil and 30% geraniol was arranged in squares of either 15 ft or 20 ft each side, with a CDC trap (without CO₂) placed in the middle. The Vaporizer Device was hung on a tripod approximately 1.2 m above the ground. The Vaporizer Device was started 15 min before the start of the experiment to grant maximum performance. The Bite Barrier Mosquito Repellent Vaporizer Refill Cartridge with All-Natural Oil (Proprietary Formulation Oil #2) was checked each night. And replaced as needed. The experiments were repeated each night. The Bite Barrier Vaporizer was tested for 4 hours per night and replicated 5 nights for each coverage area.

The results indicated the coverage of repellency for 15 and 20 feet. A CDC Trap was used to obtain the data on the effectiveness of the PIC Bite Barrier Mosquito Repellent Vaporizer, and it was compared with the data obtained in control trials.

A field trial was required to assess the coverage area of the PIC Bite Barrier Mosquito Repellent Vaporizer for repellence efficacy.

### Methodology

### Test Systems

Natural populations of flying insects in the Gurabo, Puerto Rico area were used in testing. Trapped insects were identified to at least family level.

Testing was conducted using local wild populations of mosquitos found in the open ecosystem in Gurabo, Puerto Rico (zip code 00778).

The test site was in an open area like a Terrace or Balcony environment in the Gurabo P.R. area.

The study was conducted when mosquito populations are naturally present in the test site area. Temperature, relative humidity, and percent precipitation were recorded.

Temperature and relative humidity ranged from 82 to 93° F. and 90 to 100% relative humidity during study conduct.

The test substance is the PIC Bite Barrier Mosquito Repellent Vaporizer in a ready-to-use form. Care was taken to ensure that the control device remains with power on for the duration of the testing.

After the test started, the PIC Bite Barrier Mosquito Repellent Vaporizer was allowed to run 15 minutes prior to start then undisturbed for 4 hours every night. Each morning the CDC trap was examined, and insects/parts were collected.

Three CDC light Traps are placed in the 2 different distances (15 ft and 20 ft) prior to start the test, every night collect any insect inside the trap, and identify to a family level.

The number of insects collected by the CDC trap was examined, and insects/parts were collected. The insects were identified to at least the family level using available taxonomic keys.

The number of insects found in the CDC Light Traps was reported. Results were presented in tabular form. The number of insects in each family was totaled over all replicates and a percentage of total killed insects was calculated.

Five replicates were conducted per device (1), along with the inactive control replicates run concurrently.

Replicate#1
Distance 2 (20 ft) Bite Barrier Mosquito Repellent Vaporizer

| Date Placed: | May 10, 2023 | Date Removed: | May 10, 2023 |
|---|---|---|---|
| Time Placed: | 6:00 pm | Time Removed: | 10:00 pm |
| Location: Back Yard | | | |
| Order/Family | Common name/ID | Number Trapped | Location |
| No Insects Found in CDC Light Trap | | | |
| Culicidae | Mosquito | 1 | |

Distance 2 (20 ft) Bite Barrier Mosquito Repellent Vaporizer

| | | | |
|---|---|---|---|
| Date Placed: | May 10, 2023 | Date Removed: | May 10, 2023 |
| Time Placed: | 6:00 pm | Time Removed: | 10:00 pm |
| Location: Back Yard | | | |
| Order/Family | Common name/ID | Number Trapped | Location |
| Culicidae | Mosquito | 3 | |

Replicate#2
Distance 1 (15 ft) Bite Barrier Mosquito Repellent Vaporizer

| Date Placed: | May 11, 2023 | Date Removed: | May 11, 2023 |
|---|---|---|---|
| Time Placed: | 6:00 pm | Time Removed: | 10:00 pm |
| Location: Back Yard | | | |
| Order/Family | Common name/ID | Number Trapped | Location |
| No Insects Found in CDC Light Trap | | | |
| Culicidae | Mosquito | 1 | |

Distance 2 (20 ft) Bite Barrier Mosquito Repellent Vaporizer

| | | | |
|---|---|---|---|
| Date Placed: | May 11, 2023 | Date Removed: | May 11, 2023 |
| Time Placed: | 6:00 pm | Time Removed: | 10:00 pm |
| Location: Back Yard | | | |
| Order/Family | Common name/ID | Number Trapped | Location |
| Culicidae | Mosquito | 2 | |

Replicate#3
Distance 1 (15 ft) Bite Barrier Mosquito Repellent Vaporizer

| Date Placed: | May 12, 2023 | Date Removed: | May 12, 2023 |
|---|---|---|---|
| Time Placed: | 6:00 pm | Time Removed: | 10:00 pm |
| Location: Back Yard | | | |
| Order/Family | Common name/ID | Number Trapped | Location |
| No Insects Found in CDC Light Trap | | | |
| Culicidae | Mosquito | 2 | |

Distance 2 (20 ft) Bite Barrier Mosquito Repellent Vaporizer

| | | | |
|---|---|---|---|
| Date Placed: | May 12, 2023 | Date Removed: | May 12, 2023 |
| Time Placed: | 6:00 pm | Time Removed: | 10:00 pm |
| Location: Back Yard | | | |
| Order/Family | Common name/ID | Number Trapped | Location |
| Culicidae | Mosquito | 2 | |

Replicate#4
Distance 1 (15 ft) Bite Barrier Mosquito Repellent Vaporizer

| Date Placed: | May 13, 2023 | Date Removed: | May 13, 2023 |
|---|---|---|---|
| Time Placed: | 6:00 pm | Time Removed: | 10:00 pm |
| Location: Back Yard | | | |
| Order/Family | Common name/ID | Number Trapped | Location |
| No Insects Found in CDC Light Trap | | | |
| Culicidae | Mosquito | 1 | |

Distance 2 (20 ft) Bite Barrier Mosquito Repellent Vaporizer

| | | | |
|---|---|---|---|
| Date Placed: | May 13, 2023 | Date Removed: | May 13, 2023 |
| Time Placed: | 6:00 pm | Time Removed: | 10:00 pm |
| Location: Back Yard | | | |
| Order/Family | Common name/ID | Number Trapped | Location |
| Culicidae | Mosquito | | |

Replicate#5
Distance 1 (15 ft) Bite Barrier Mosquito Repellent Vaporizer

| Date Placed: | May 14, 2023 | Date Removed: | May 14, 2023 |
|---|---|---|---|
| Time Placed: | 6:00 pm | Time Removed: | 10:00 pm |
| Location: Back Yard | | | |
| Order/Family | Common name/ID | Number Trapped | Location |
| No Insects Found in CDC Light Trap | | | |
| Culicidae | Mosquito | 2 | |

Distance 2 (20 ft) Bite Barrier Mosquito Repellent Vaporizer

| | | | |
|---|---|---|---|
| Date Placed: | May 14, 2023 | Date Removed: | May 14, 2023 |
| Time Placed: | 6:00 pm | Time Removed: | 10:00 pm |
| Location: Back Yard | | | |
| Order/Family | Common name/ID | Number Trapped | Location |
| Culicidae | Mosquito | 3 | |

### Bite Barrier Mosquito Repellent Vaporizer Test Coverage Area

TABLE 1
Data collected on the Bite Barrier Mosquito Repellent
Vaporizer Coverage Area

| Replicate | 15 ft | 20 ft | Control |
|---|---|---|---|
| 1 | 1 | 3 | 13 |
| 2 | 1 | 2 | 10 |
| 3 | 2 | 2 | 11 |
| 4 | 1 | 1 | 14 |
| 5 | 2 | 3 | 13 |
| Total | 7 | 11 | 61 |

### Analysis

The experiment conducted to determine the coverage area by Bite Barrier Mosquito Repellent Vaporizer showed 89% of repellency when tested 15 feet away from the CDC trap. In the test where the repellent vaporizer was placed 20 feet away from the CDC trap, 81% mosquito repellency was obtained. This experiment confirms that the distance claimed for Bite Barrier Mosquito Repellent Vaporizer could be (r=15 ft) with 89% mosquito repellency, or (r=20 ft) with 81% mosquito repellency.

### REFERENCES

1. Barnard, D. R., Xue, R., 2004. Laboratory evaluation of mosquito repellents against Aedes albopictus, Culex nigripalpus, and Ochlerotatus triseriatus (Diptera: Culicidae). Journal of Medical Entomology 41, 726-730.
2. Jeon, J. H., Lee, C. H., Lee, H. S., 2009. Food protective effect of geraniol and its congeners against stored food mites. Journal of Food Protection 72, 1468-1471.
3. Moore, S. & Debboun, M. (2007) History of insect repellents. Insect Repellents: Principles, Methods, and Uses (ed. by M. Debboun, S. P. Frances & D. Strickman), pp. 3-30. CRC Press, BocaRaton, FL.
4. Pattanayak, M., Seth, P. K., Smita, S., Gupta, S. K., 2009. Geraniol and limonene interaction with 3-hydroxy-3-methylglutaryl CoA (HMG-COA) reductase for their role as cancer chemo-preventive agents. Journal of Proteomics & Bioinformatics 11, 466-474.
5. Tawatsin, A. et al. Field evaluation of deet, Repel Care®, and three plant-based essential oil repellents against mosquitoes, black flies (Diptera: Simuliidae), and land leeches (Arhynchobdellida: Haemadipsidae) in Thailand. J. Am. Mosq. Control Assoc. 22, 306-313 (2006).
6. Fradin, M. S. & Day, J. F. Comparative efficacy of insect repellents against mosquito bites. N. Engl. J. Med. 347, 13-18 (2002).
7. Kuehn, B. M. CDC: New repellents for West Nile fight. JAMA 293, 2583 (2005).
8. Chellappandian, M. et al. Botanical essential oils and uses as mosquitocides and repellents against dengue. Environ. Int. 113, 214-230 (2018).
9. Pohlit, A., Lopes, N., Gama, R., Tadei, W. & de AndradeNeto, V. Patent literature on mosquito repellent inventions which contain plant essential oils-A review. Planta Med. 77, 598-617 (2011).
10. Mapossa, A. B., Focke, W. W., Tewo, R. K., Androsch, R. & Kruger, T. Mosquito-repellent controlled-release formulations for fighting infectious diseases. Malar. J. 20, 165 (2021).

1. A composition comprising a mixture of essential oils and terpene alcohol.

2. The composition of claim 1, wherein the mixture of essential oils comprises clove oil, citronella oil, lemongrass oil, peppermint oil, lavender oil, sandalwood oil, basil oil, bergamot oil, camphor oil, cinnamon oil, clove oil, eucalyptus oil, jasmine oil, lemon oil, patchouli oil, rosemary oil, wild turmeric oil, rose oil, and chamomile oil;
(a) preferably, the mixture of essential oils comprises clove oil, citronella oil, lemongrass oil, peppermint oil, lavender oil, sandalwood oil, basil oil, bergamot oil, camphor oil, cinnamon oil, clove oil, eucalyptus oil, jasmine oil, lemon oil, patchouli oil, rosemary oil, and wild turmeric oil;
(b) more preferably, the mixture of essential oils comprises clove oil, citronella oil, lemongrass oil, peppermint oil, lavender oil, sandalwood oil, basil oil, bergamot oil, camphor oil, cinnamon oil, clove oil, eucalyptus oil, jasmine oil, lemon oil, and patchouli oil;
(c) more preferably, the mixture of essential oils comprises clove oil, citronella oil, lemongrass oil, peppermint oil, lavender oil, sandalwood oil, basil oil, bergamot oil, camphor oil, cinnamon oil, clove oil and eucalyptus oil, and jasmine oil;
(d) more preferably, the mixture of essential oils comprises clove oil, citronella oil, lemongrass oil, peppermint oil, lavender oil, sandalwood oil, basil oil, bergamot oil, and camphor oil; and
(e) more preferably, the mixture of essential oils comprises clove oil, citronella oil, lemongrass oil, peppermint oil, and lavender oil.

3. The composition of claim 2, wherein the mixture of essential oils comprises clove oil, citronella oil, and lemongrass oil.

4. The composition of claim 3, wherein the weight percentage of clove oil is about 1% to 20%; preferably, 5% to 15%; more preferably, 6% to 14%; more preferably, 7% to 13%;
more preferably, 8% to 12%; and more preferably, 9% to 11%.

5. The composition of claim 4, wherein the weight percentage of clove oil is 10%.

6. The composition of claim 2, wherein the weight percentage of lemongrass oil is about 20%-40%; preferably, 21%-39%; more preferably, 22%-38%; more preferably, 23%-37%; more preferably, 24%-36%; more preferably, 25%-35%; more preferably, 26%-34%; more preferably, 27%-33%; more preferably, 28%-32%; and more preferably, 29%-31%.

7. The composition of claim 6, wherein the weight percentage of lemongrass oil is 30%.

8. The composition of claim 2, wherein the weight percentage of citronella oil is about 20%-40%; preferably, 21%-39%; more preferably, 22%-38%; more preferably, 23%-37%; more preferably, 24%-36%; more preferably, 25%-35%; more preferably, 26%-34%; more preferably, 27%-33%; more preferably, 28%-32%; and more preferably, 29%-31%.

9. The composition of claim 8, wherein the weight percentage of citronella oil is 30%.

10. The composition of claim 2, wherein the weight percentage of terpene alcohol is about 10%-50%; preferably, 15%-45%; more preferably, 28%-42%; more preferably, 20%-40%; more preferably, 21%-39%; more preferably, 22%-38%; more preferably, 23%-37%; more preferably, 24%-36%; more preferably, 25%-35%; more preferably, 26%-34%; more preferably, 27%-33%; more preferably, 28%-32%; and more preferably, 29%-31%.

11. The composition of claim 10, wherein the weight percentage of terpene alcohol is 30%.

12. The composition of claim 2, wherein the terpene alcohol comprises cinnamyl alcohol, citronellol, geraniol, nerol, farnesol, linalool, perillyl alcohol, menthol, borneol, and carveol;
(a) preferably, the terpene alcohol comprises citronellol, geraniol, nerol, farnesol, linalool, perillyl alcohol, menthol, borneol, and carveol;
(b) more preferably, the terpene alcohol comprises citronellol, geraniol, nerol, farnesol, linalool, perillyl alcohol, menthol, and borneol;
(c) more preferably, the terpene alcohol comprises citronellol, geraniol, nerol, farnesol, linalool, perillyl alcohol, and menthol;
(d) more preferably, the terpene alcohol comprises citronellol, geraniol, nerol, farnesol, linalool, and perillyl;
(e) more preferably, the terpene alcohol comprises citronellol, geraniol, nerol, farnesol, and linalool;
(f) more preferably, the terpene alcohol comprises citronellol, geraniol, nerol, and farnesol; and
(g) more preferably, the terpene alcohol comprises citronellol and geraniol.

13. The composition of claim 12, wherein the terpene alcohol is geraniol.

14. The composition of claim 2, wherein the composition comprises 30% citronella oil, 30% lemongrass oil, 10% clove oil and 30% geraniol.

15. The composition of claim 2, wherein the composition further comprises a solubilizer, an emulsifier, an adjuvant and/or distilled water; preferably, the weight percentage of distilled water is about 50-70%; more preferably, 40-60%; more preferably, 45-55%; more preferably, 50%.

16. The composition of claim 2, wherein the composition is a topical formulation; or the composition is an oil-in-water emulsion; preferably, the topical formulation is in the form of vapor, liquid, gel, cream, or ointment.

17. An article containing a composition of claim 2.

18. A method of preparing a composition of claim 2.

19. A method of using the composition of claim 2 to repel insects.

20. The method of claim 19, wherein the insect comprises mosquito, crane fly, fly, winter crane fly, owl midge, wood gnat, midge, fungus gnat, gnat, dixidae, pyschodidae, and anisopodidae;
(a) preferably, the insect comprises mosquito, crane fly, fly, winter crane fly, owl midge, wood gnat, midge, fungus gnat, and gnat;
(b) more preferably, the insect comprises mosquito, crane fly, fly, winter crane fly, owl midge, wood gnat, midge, fungus gnat, and gnat;
(c) more preferably, mosquito, crane fly, fly, winter crane fly, owl midge, and midge;
(d) more preferably, mosquito, crane fly, fly, and winter crane fly; and
(e) more preferable, the insect is mosquito.
